(19) United States
(12) Patent Application Publication
(10) Pub. No.: US 2011/0169750 A1
(43) Pub. Date: Jul. 14, 2011

(54) MULTI-TOUCHPAD MULTI-TOUCH USER INTERFACE

(75) Inventors: David Pivonka, Winfield, IL (US); Shafer Seymour, Bartlett, IL (US)

(73) Assignee: CONTINENTAL AUTOMOTIVE SYSTEMS, INC., Deer Park, IL (US)

(21) Appl. No.: 12/687,478

(22) Filed: Jan. 14, 2010

(51) Int. Cl. G06F 3/041

(52) U.S. Cl. 345/173

(57) ABSTRACT

A user interface assembly includes a first touch sensitive pad and a second touch sensitive pad spaced apart from each other that both sense a position of corresponding objects on each touch sensitive pad and synchronizes those positions into an output that relates the sensed positions to corresponding positions on a mapped device.

### BACKGROUND

This disclosure generally relates to a user interface for a computer controlled device. More particularly, this disclosure generally relates to a user interface that utilizes more than one touchpad for interfacing with a computer controlled device.

A touchpad is a known device that is typically installed into a portable computer for interfacing and controlling operation of various computer programs. A touchpad recognizes specific touches and motions as an intuitive control and a substitute or supplement for moving a pointing device such as a mouse or a track ball. Multi-touch touch pads recognize multiple touch points on a single touch pad and the relationship between those touch points. Movement of the touch points relative to each other can be utilized as a command signal to further direct features and control a software program. For example, two fingers touching a touchpad and moved apart can command an expanding or enlarging view. Moving fingers toward each other can relate to reducing or focusing a view.

Control buttons are currently provided on an automotive steering wheel to control various features while allowing an operator to maintain both hands on the steering wheel. As vehicles become further integrated with music, mapping and other entertainment and information accessories, the control input devices required to operate the increasing options continues to grow in number. In many instances, instead of providing a button for each application or function, a limited number of buttons are provided, where each has multiple functions. Further, touch screens are also increasingly being mounted in a dashboard or center console and are utilized to reduce the number of traditional buttons required to operate the many functions. Disadvantageously, such touch screens require an operator to remove a hand from a steering wheel. Moreover, many of the features utilized in a multi-touch pad cannot be enabled in a vehicle application in order to aid in focusing the driver on the task of driving a vehicle.

Accordingly, it is desirable to design and develop improved methods and devices for controlling various types of technology incorporated into a vehicle while maintaining an operator's focus on operating the motor vehicle.

### SUMMARY

A disclosed user interface assembly includes a first touch sensitive pad and a second touch sensitive pad spaced apart from each other so that both sense respective touched positions. The user interface assembly synchronizes those positions into an output that relates the sensed positions to corresponding positions on a mapped device. The user interface assembly combines sensed positions of different objects on different spaced apart touch sensitive pads to generate a control output indicative of a relative corresponding position on the mapped device. The separate outputs are synchronized to produce multi-touch gestures from separate detected movements and positions on separate touch sensitive pads.

A disclosed example user interface is embedded within a steering wheel and includes first and second touch sensitive pads spaced apart from each other. A position and movement of a thumb or finger on each hand are detected on the separate touch sensitive pads allowing an operator to maintain both hands on the steering wheel while generating multi-touch gestured commands. The position and movement of each thumb or finger on the separate touch sensitive pads are synchronized to generate the relative movement therebetween that provides the multi-touch gestured commands. Accordingly, a disclosed example user interface provides multi-touch control with separated synchronized touch sensitive pads.

These and other features disclosed herein can be best understood from the following specification and drawings, the following of which is a brief description.

### BRIEF DESCRIPTION OF THE DRAWINGS

FIG. 1 is a schematic view of an example vehicle instrument panel and steering wheel.

FIG. 2 is a schematic view of operation of an example multi-touchpad user interface.

FIG. 3 is a schematic view of operation of an example multi-touchpad user interface.

FIG. 4 is a schematic view of an example input motion on the example multi-touchpad user interface.

FIG. 5 is a schematic view of another example input motion on the example multi-touchpad user interface.

FIG. 6 is a schematic view of another example input motion on the example multi-touchpad user interface.

FIG. 7 is a schematic view of another example input motion on another example multi-touchpad user interface.

FIG. 8 is a schematic view of one of the example touchpads including a switch.

### DETAILED DESCRIPTION

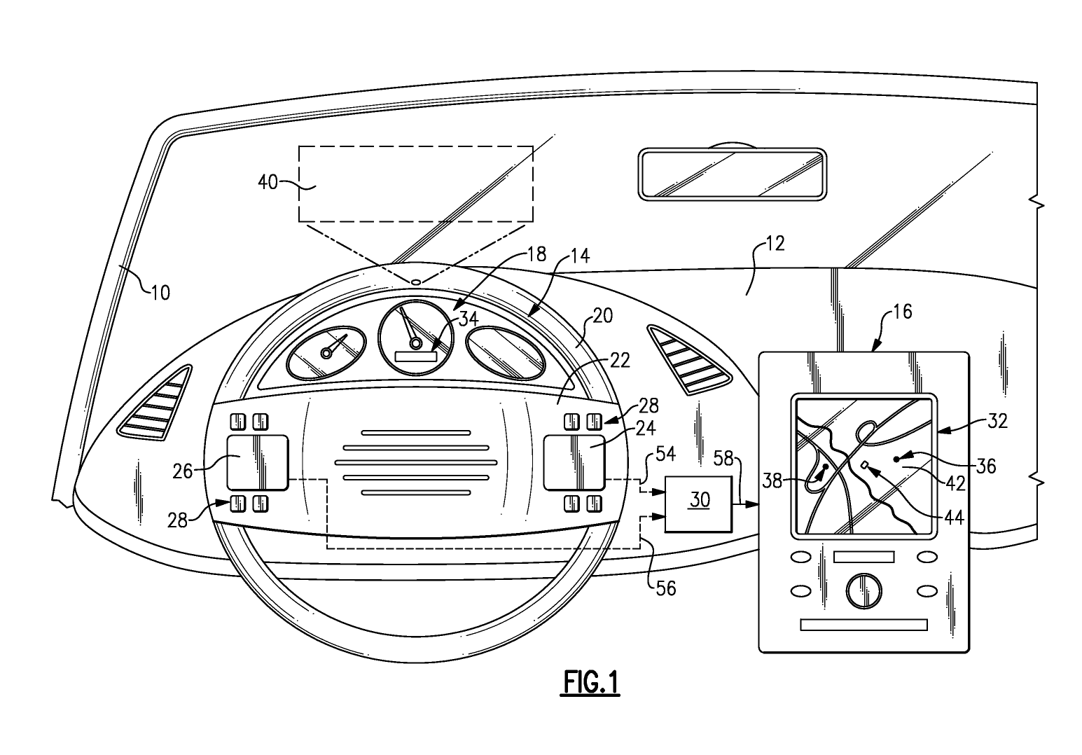

Referring to FIG. 1, an example motor vehicle 10 includes a dashboard 12 for supporting instrumentation and controls for an operator. The dashboard 12 includes a center console 16 with a display screen 32. The dashboard 12 also includes an instrument panel 14 that includes a plurality of gauges 18. The gauges 18 communicate information indicative of vehicle operating conditions.

Steering wheel 20 includes control buttons 28 and first and second touch sensitive pads 24, 26 that activate features of the vehicle 10, such as a radio or other features that have controls generated on the display 32. Images generated on the display 32 provide a graphical representation of current settings for a radio or other entertainment and information functions such as a map for navigation. As appreciated, the number of devices and features that are controllable within the vehicle 10 is ever increasing, and this disclosure includes limited examples of possible entertainment and information features and is applicable to any controllable feature or device.

Furthermore, although the example display 32 is mounted within a center console 16 of the dashboard 12, other displays can also be controlled and utilized. The example gauge 18 can include a display 34 for communicating data indicative of vehicle operation. The display 34 can be utilized to communicate information such as miles driven, range, and any other information potentially useful and desirable to a vehicle operator. Moreover, the vehicle 10, can include a heads up display 40 that is projected within a view of the operator in order to allow attention to be maintained on the road while controlling and viewing information concerning vehicle operation. Other example displays as can be imagined for use in communicating information to a vehicle operator will benefit from the disclosure herein.

Much of the increasing amount of information and available entertainment options within a vehicle are controlled by buttons 28 disposed on the steering wheel 20. The buttons on the steering wheel allow control and actuation of many features without removing hands from the steering wheel 20. However, some command options and motions are not available or possible with simple button actuation. The example steering wheel 20 includes the first and second touch sensitive pads 24, 26 that expand the possible functions and control provided to an operator.

The example touch sensitive pads 24, 26 sense one or more respective touches by an operator's thumbs or fingers to interface with a mapped device such as for example an image including graphical user interface displayed on one of the displays 32, 34 and 40. Although the example mapped device is an image including a graphical user interface, other devices and/or controls that are mapped to correspond to sensed positions on the touch pads 24, 26 will also benefit from this disclosure. The first and second touch sensitive pads 24, 26 can provide for movement of a cursor or other graphical feature within the display 32, to select and control functions. For example, movements performed on the first and second touch sensitive pads 24, 26 can be used as is commonly known to move a cursor to select a desired feature or action represented by an icon image viewed on the display 32.

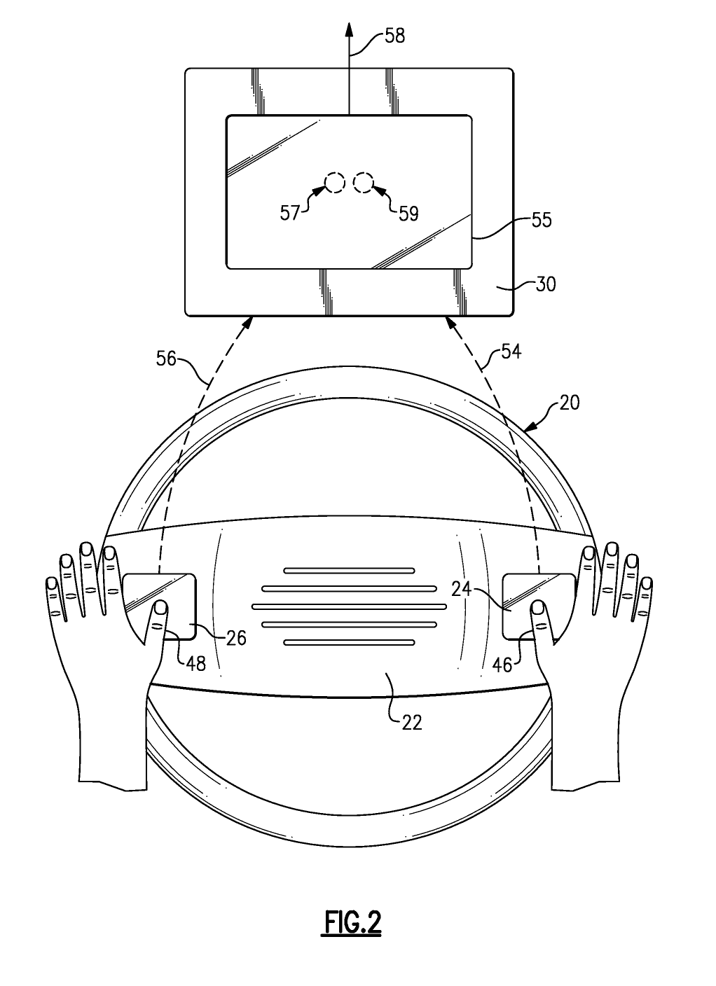

Referring to FIG. 2 with continued reference to FIG. 1, inputs 54, 56 from each of the first and second touch sensitive pads 24, 26 may be synchronized by a controller 30 to generate an output 58 as if the sensed position of objects 46 and 48 was performed on a single touch pad. The controller 30 may take the separate inputs 54, 56 and synchronize them to replicate a single touchpad. In this example, operator's thumbs 46, 48 are detected on corresponding touch pads 24, 26 to produce corresponding outputs 54, 56. The controller 30 receives those outputs, synchronizes them and may interpret them as if they were produced on a single touch sensitive device or virtual touchpad 55. Thereby, the separate positions of the thumbs 46, 48 may be synchronized by the controller 30 to operate as if they were placed at positions 57 and 59 on the single virtual touchpad 55. The position information input into the controller 30 from each of the touch pads 24, 26 may be interpreted as one of the positions 57 and 59 on the virtual touchpad 55. The positions 57 and 59 may be determined based on the sensed positions of the thumbs 46 and 48 on each of the separate touch pads 24, 26.

The example virtual touchpad 55 is not physically present, but is illustrated to exemplify how sensed positions from separate touch pads 24, 26 are combined to correspond to positions on a mapped device. The example mapped device can be the example virtual touchpad 55, but may also correspond to positions on an image projected on a display device, or any other device having mapped locations that correspond to points on the individual touch pads 24, 26.

Multi-touch gestures may be utilized as command inputs to expand, contract, focus, and/or move an image using detected relative movement between multiple fingers or thumbs. The combination of sensed positions on the first and second touch pads 24, 26 provide for the inclusion of such multi-touch gestured commands with recognition and synchronization of sensed finger movements on each of the first and second touch sensitive pads 24, 26.

The example first and second touch sensitive pads 24, 26, sense one or more respective positions of the operators fingers or thumbs 46,48 shown here, and generates corresponding inputs 54, 56 indicative of that sensed position and/or movement to the controller 30. The example controller 30 utilizes the inputs 54, 56 from each of the first and second touch sensitive pads 24, 26 to generate the output 58 that relates to the sensed position and/or movement that corresponds to a desired position or movement on the image 42 or other mapped device. Further, specific gestures can be interpreted and utilized to command manipulation of an image 42 on the display 32.

It should be noted that the example controller 30 can be a dedicated controller for the information system controlling the various displays and images. Further, the controller 30 can be part of a vehicle control module that governs operation of the vehicle. In any case, the controller 30 can include a processor, a memory, and one or more input and/or output (I/O) device interface(s) that are communicatively coupled via a local interface. The local interface can include, for example but is not limited to, one or more buses and/or other wired or wireless connections. The local interface may have additional elements, which are omitted for simplicity, such as controllers, buffers (caches), drivers, repeaters, and receivers to enable communications.

The example first and second touch sensitive pads 24, 26 are comprised of a surface mounted within the steering wheel housing 22 that is accessible by an operator's finger while grasping the steering wheel. The first and second touch sensitive pads 24, 26 can utilize any known method of sensing a position of an object within the region defined by the surface of the individual touch sensitive pad. Example methods of sensing the position of the operators finger or thumb include capacitive and conductance sensing. Other methods of sensing the position of an object or finger on the touch pad are within the contemplation of this disclosure.

What ever method or system is utilized, the example touch sensitive pads 24, 26 sense a position of the operator's finger or thumb and movements of the sensed object within the space defined by the corresponding pads 24, 26. Each of the touch sensitive pads 24, 26 can operate independently to provide control of a feature or selection of an icon displayed on the display 32. Such operation provides for the optional use of either the left or the right hand for some commands. For example, the left pad might be used to change a slider control to alter the temperature setting for the driver's side of the vehicle, while the right pad controls the passenger side of the vehicle.

The example touch sensitive pads 24, 26 may also provide multi-touch operation by synchronizing operation to replicate the single multi-touch virtual pad 55 that recognizes more than one finger and relative movement between the two detected fingers. Such recognition and synchronization provides for the use of gestures and commands that are typically possible through the use of a single multi-touch capable touch sensitive pad.

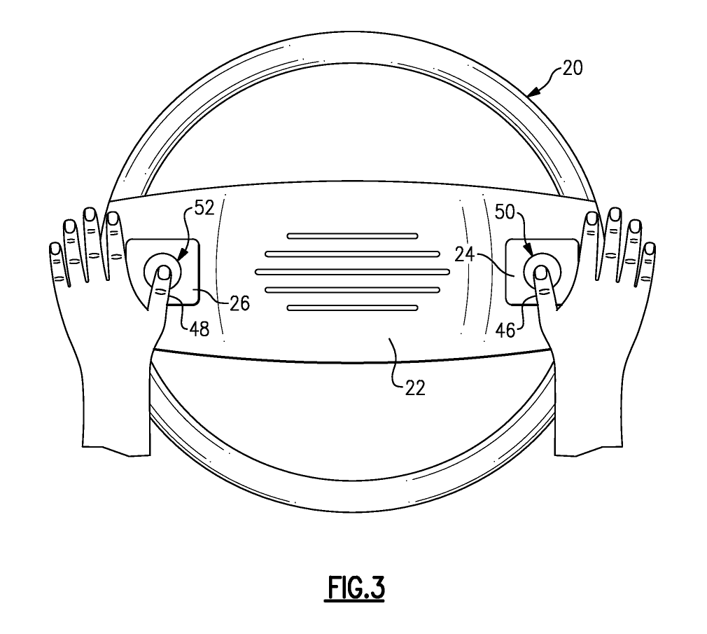

Referring to FIG. 3, with continued reference to FIG. 1, synchronization of movements on the separate first and second touch sensitive pads 24, 26 begins by determining a home position for each of the operator's fingers 46, 48. In this example, each of the first and second touch sensitive pads 24, 26 include a defined home region 50, 52. The example home regions 50, 52 are defined by visible lines provided on the surface of each of the first and second touch sensitive pads 24, 26, though such lines are not required by this invention and may not be present in some implementations. Placement of the operator's thumbs 46, 48 within the home regions 50, 52 indicate that the operator is beginning a command operation and matches the position of each thumb 46, 48 to a corresponding fixed starting point on the image 42. As appreciated, such a starting point would not be visibly displayed on the image 42, but is indicated at 44 for illustrative purpose.

The home position is attained in this example by placing the thumbs 46, 48 within the defined home regions 50, 52 for a defined time. After a period of time elapses, the controller 30 synchronizes input into each of the first and second touch sensitive pads 24, 26 to provide multi-touch gesture information. The home position can also be initiated by placing the thumbs 46, 48 within the home regions 50, 52 and actuating one of the plurality of buttons 28 to indicate that synchronization is desired. Some implementations may include a button on the rear surface of the wheel, which would be easier to reach when the wheel is gripped normally, and the thumb is place on the touch-pad. Further, the home positions can be initiated by tapping each touch sensitive pad 24, 26 followed by holding the thumbs 46, 48 in place for a defined time. As appreciated, many different initiation signals could be utilized to signal that synchronization of movements on each of the separate touch sensitive pads 24, 26 is desired.

Once the home position is defined by the detection of the operator's thumbs 46, 48 within the home regions 50, 52, relative movement of the thumbs 46, 48 away from the home regions 50,52 can be utilized to generate corresponding commands to manipulate the image 42.

Referring now also to FIG. 4 with continued reference to FIG. 1, movement of each thumb 46, 48 toward an outside of the steering wheel 20 and away from the home region 50, 52 to replicate an “unpinch” gesture and may be used to specify a zoom-in operation on a specific image on the display 32. As appreciated, movement away from the virtual home position 42 would not usually generate a visible location; however, the example image 42 includes virtual points 36, 38 that illustrate the corresponding position of the thumbs 46, 48 on the image 42. In the illustrated example the image 42 comprises a map and movement of the thumbs 46, 48 away from the home regions 50, 52 zooms in the map display and shows a decreased area with increased magnification. In other examples, the same gesture of moving the thumbs 46, 48 away from the home regions 50, 52 could be utilized to zoom out a picture or other image.

Regardless of the specific function allocated to correspond with movement of an operator's thumbs 46, 48 away from the home regions 50, 52, the controller 30 synchronizes the movements on the individual and spaced apart touch sensitive pads 24, 26 as a single multi-touch movement. The controller 30 relates the home regions 50, 52 and the movement away from those home regions as a relative distance that increases between the thumbs 46, 48 on the different touch pads 24, 26. This synchronized movement is determined and generated to correspond to movements utilized to modify the image 42.

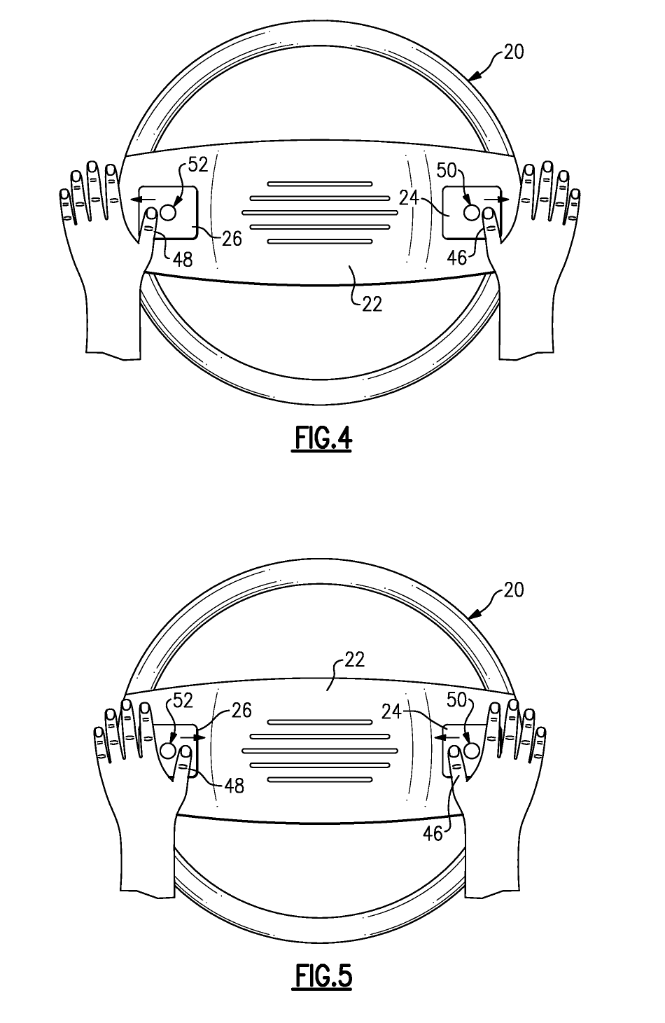

Referring now also to FIG. 5, movement of the thumbs 46, 48 toward the inside of the steering wheel 20 can be utilized to zoom out the image 42. The movement inwardly from the home regions 50, 52 is recognized as movement of detected points toward each other in a pinching manner The relative pinching movement is then utilized to provide the corresponding modification to the image 42. In this example, movement of the thumbs 46, 48 toward the inner portion of the steering wheel corresponds to an expanding view or zooming out of the map. In other examples, the same motion may also correspond to expansion of an image on the display depending on the current application and function being utilized by the operator.

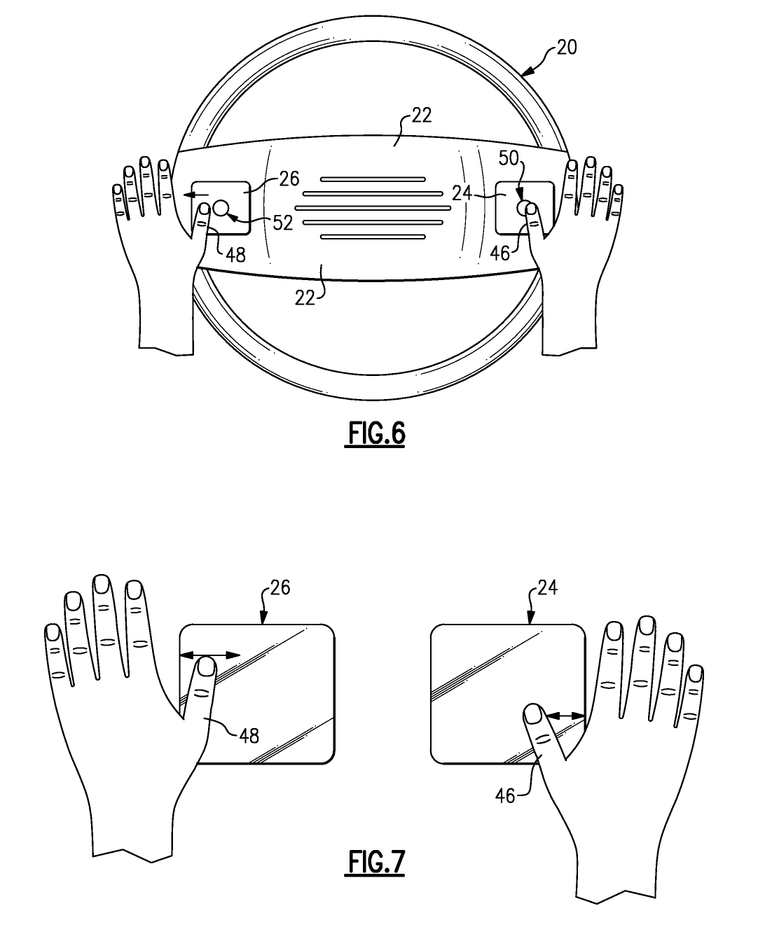

Referring now also to FIG. 6, with continued reference to FIG. 1, other movements can also be recognized as a pinching or expanding movement. In this example, the thumb 46 is held within the home region 50 and the thumb 48 is moved relative to the corresponding home region 52. This movement is recognized as if both thumbs were moving on a common touch pad and the thumb 48 was moved away from the thumb 46. This is so, because the initialization of synchronization set the virtual home position 44 of the thumbs 46 and 48 relative to each other as if placed on the virtual touchpad 55 (As shown in FIG. 2). Therefore, movement of one of the thumbs 46, 48 away from the home position is interpreted as moving the thumbs 46, 48 away from each other. Accordingly, movement of either of the thumbs 46, 48 away from the home position is interpreted as movement away from the other thumb with regard to manipulation of the image.

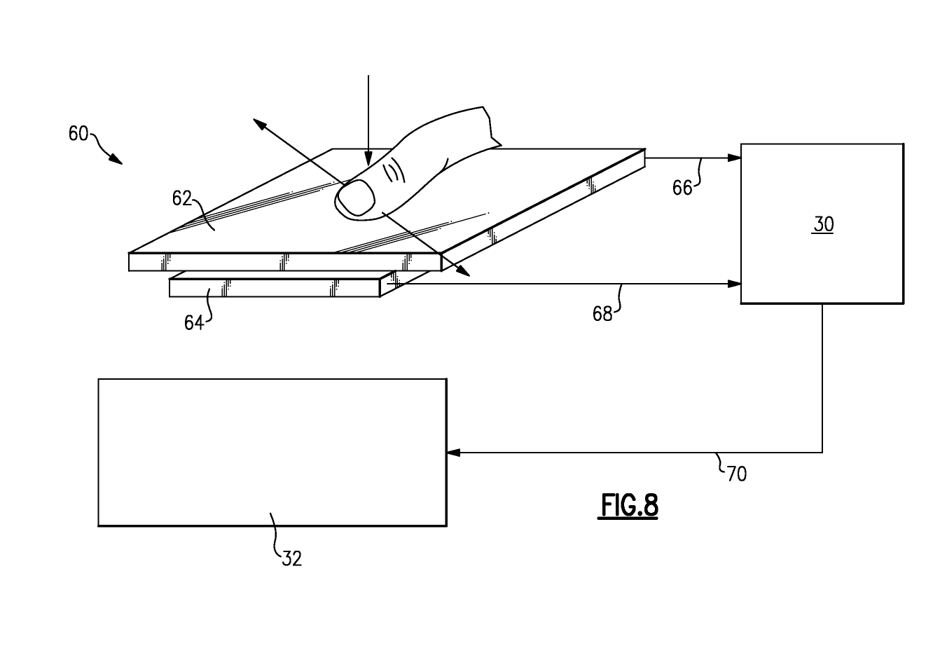

Referring to FIG. 7, another example of determining a home region initializes the actuation of the home region in response to the first sensed touch, regardless where on the touch sensitive pad the thumb is sensed. Upon initial touching of the touch sensitive pads 24, 26 with a corresponding thumb 46, 48, that initial position is mapped to correspond to the virtual home position 44 on the image 42 or any other mapped device.

Alternatively, the mapped position of each of the thumbs 46, 48 could be set to correspond to a relative location on each touchpad 24, 26 and not necessarily at a home position. As appreciated, pinching and unpinching gestures need not be restricted to beginning at a defined home position. Instead, mapping the relative position of the thumbs on the separate touch pads 24, 26 as if they were on a single virtual touch screen could be utilized to provide the desired commands.

In this example, the position of the thumbs 46, 48 can correspond to a position on a mapped device such as the image 42 on the display 32. The thumb 48 placed in an upper left corner of the touch sensitive pad 26 will set this first touch point as corresponding to the upper left corner of the image 42. The position of the thumb 46 would also be so set to reflect a position on the image 42 corresponding with the location on the touch sensitive pad 24.

From this initial position, relative movement would be detected and the output from the controller 30 set to be indicative of the relative movement of the thumbs 46, 48 as if each where present on the same touch sensitive pad corresponding to the mapped device. The inputs 54, 56 from each touch sensitive pad 24, 26 would therefore be indicative of a corresponding position on the image 42. The controller 30 interprets the inputs 54, 56 as such and generates the control output 58 indicative of the relative movements between the corresponding locations.

Referring to FIG. 8, an example touch sensitive pad 60 includes a switch 64 that can be actuated by pressing on the pad 62. The switch 64 provides an input 68 that is utilized by the controller 30. The pad 62 generates an output 66 that is indicative of a position of the finger on the touch pad 62 to generate an output utilized to control and/or manipulate an image. The input from the switch 64 can be utilized with each of the spaced apart pads 24, 26 (FIGS. 1-7) to initiate synchronization. Further, the switch 64 can be utilized to provide inputs for controlling additional features within the vehicle.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A user interface assembly comprising:
a first touch sensitive pad that senses a position of a first object;
a second touch sensitive pad that senses a position of a second object, the second touch sensitive pad spaced apart from the first touch pad; and
a controller that synchronizes inputs from each of the first and second touch sensitive pads relative to each other on a common mapped device.

2. The user interface assembly as recited in claim 1, wherein the controller synchronizes inputs from the first and second touch sensitive pads to corresponding points on the common mapped device.

3. The user interface assembly as recited in claim 2, wherein the mapped device comprises a virtual touch pad.

4. The user interface assembly as recited in claim 1, wherein the controller generates a control output that relates the sensed position of the first and second objects to a position on a displayed image.

5. The user interface assembly as recited in claim 1, wherein at least one of the first and second touch sensitive pads includes a home region that defines a starting point corresponding to a home region on the common mapped device.

6. The user interface assembly as recited in claim 5, wherein the first and second touch sensitive pads include a visible indicator of the home region that separates the home region from surrounding regions of the first and second touch sensitive pads.

7. The user interface assembly as recited in claim 6, wherein the controller generates an output responsive to positioning of the first and second objects within the home region of each of the first and second touch sensitive pads that relates to a desired position on the mapped device.

8. The user interface assembly as recited in claim 7, wherein the controller generates an output responsive to moving the first and second objects relative to respective ones of the first and second touch sensitive pads to control modification of a displayed image.

9. The user interface assembly as recited in claim 1, wherein each of the first and second touch sensitive pads includes a respective switch that can be actuated by pressing a corresponding one of the first and second touch sensitive pads.

10. The user interface assembly as recited in claim 1, wherein the first and second objects comprise fingers on different hands of an operator.

11. The user interface as recited in claim 1, wherein the common mapped device comprises at least one display device that generates an image, where the image is controlled by outputs generated from the controller.

12. The user interface as recited in claim 11, wherein the controller synchronizes inputs from each of the first and second touch sensitive pads indicative of a sensed position of at least one of the first object and the second object and generates a control output that relates the sensed position to a position on the common mapped device.

13. The user interface as recited in claim 1, wherein at least one of the first and second touch sensitive pads are disposed within a vehicle steering wheel.

14. The user interface assembly as recited in claim 1, wherein the first and second touch sensitive pads are positioned on opposing sides a vehicle steering wheel.

15. A method of synchronizing a plurality of touch sensitive pads comprising:
sensing a first position of a first object on a first touch sensitive pad;
sensing a second position of a second object on a second touch sensitive pad spaced apart from the first touch sensitive pad; and
generating an output indicative of the first object and the second object that corresponds to locations on a mapped device responsive to receiving a first input indicative of the sensed first position of the first object on the first touch sensitive pad and a second input indicative of the sensed second position of the second object on the second touch sensitive pad.

16. The method as recited in claim 15, including the step of defining a home region in each of the first and second touch sensitive pads that corresponds to a desired position on the mapped device.

17. The method as recited in claim 15, including the step of setting the first position and the second position of the first and second objects sensed on the corresponding first and second touch sensitive pads at the desired position responsive to an initiation indication.

18. The method as recited in claim 17, wherein the initiation indication includes holding each of the first and second objects at corresponding home regions for a desired time.

19. The method as recited in claim 17, wherein each of the first and second touch sensitive pads comprises a switch responsive to a desired pressure on the corresponding first and second touch sensitive pads and the initiation indication comprises pressing the switch for each of the corresponding first and second touch sensitive pads.

20. The method as recited in claim 17, including the step of modifying an image on the mapped device responsive to moving at least one of the first and second objects away from the home position.
